(19) United States
(12) Patent Application Publication
(10) Pub. No.: US 2024/0094333 A1
(43) Pub. Date: Mar. 21, 2024

(54) RADAR SYSTEM FOR MOTOR VEHICLES

(71) Applicant: Robert Bosch GmbH, Stuttgart (DE)

(72) Inventors: Armin Himmelstoss, Weissach Im Tal (DE); Daniel Schindler, Korntal-Münchingen (DE); Juergen Hasch, Stuttgart (DE); Martin Fink, Leonberg (DE); Thomas Binzer, Ingersheim (DE)

(21) Appl. No.: 18/263,569

(22) PCT Filed: May 4, 2022
(86) PCT No.: PCT/EP2022/062015

§ 371 Date: Jul. 31, 2023

(30) Foreign Application Priority Data
Jun. 28, 2021 (DE) 10 2021 206 668.2
Jul. 8, 2021 (DE) 10 2021 207 215.1

(51) Int. Cl. G01S 7/03; G01S 13/931

(52) U.S. Cl. CPC G01S 7/03; G01S 13/931

(57) ABSTRACT

A radar system for motor vehicles. The radar system has multiple transceiver units, which are situated on separate installation supports for the installation in different locations in the motor vehicle and are connected to one another by a synchronization network. Each of the transceiver units has a scanning module for scanning radar signals received on a plurality of channels in the form of a time signals. Each installation support has a raw-data interface for the transmission of the time signal of the transceiver unit to a central evaluation instance. The central evaluation instance is configured to jointly evaluate the time signals from the plurality of transceiver units.

### FIELD

The present invention relates to a radar system for motor vehicles having a plurality of transceiver units, which are situated on separate installation supports for the installation at different locations in the motor vehicle and connected to one another by a synchronization network and have a scanning module for scanning radar signals received on multiple channels in the form of a time signal.

### BACKGROUND INFORMATION

Radar systems are employed in driver-assistance systems such as for a distance control and/or for collision warning or collision avoidance, and in systems for autonomous driving for the purpose of acquiring the traffic environment. In the wake of steadily increasing performance demands, especially with regard to the angular resolution of the radar sensors, radar sensors having a large antenna aperture are being used to an increasing extent.

In PCT Patent Application No. WO 2018/137809 A1, a radar system for motor vehicles is described, which has a plurality of mutually synchronized transceiver units so that a large number of receiving channels are available overall and a high-resolution angle measurement is possible by comparing the amplitudes and phases of radar echoes received from the plurality of antennas that are offset from one another. In this context, it is also not excluded that the plurality of transceiver units is installed in positions in the motor vehicle that are situated at a relatively great distance from one another.

The transceiver units typically operate according to the FMCW principle (Frequency-Modulated Continuous Wave). The frequency of the transmitted radar signals is modulated in a ramp-type manner. Within each measuring cycle, a sequence of frequency ramps is transmitted. The radar echoes received in each receiving channel are mixed with a component of the signal transmitted at the receiving time so that a beat signal having a lower frequency is obtained. Because of the distance dependency of the signal propagation times and because of the dual effect, the beat frequency depends both on the object distance and the relative velocity of the object. Different methods are available by which the distance-dependent components and the velocity-dependent components can be separated from one another. In general, the time signal recorded across a measuring cycle is converted by a one-dimensional or multi-dimensional Fourier transform into a frequency spectrum in which each located object is marked by a peak at a specific frequency.

### SUMMARY

It is an object of the present invention to provide a cost-efficient radar system that offers greater performance.

According to the present invention, this object may be achieved in that each installation support has a raw-data interface with a central evaluation instance for ascertaining the time signal of the transceiver unit, and the central evaluation instance is configured to jointly evaluate the time signals from the plurality of transceiver units.

According to an example embodiment of the present invention, the installation supports can be installed in the vehicle in positions that are relatively far from one another but must be in a fixed spatial relationship with one another so that the antennas of the plurality of transceiver units, taken as a whole, result in a very large aperture. However, the individual installation supports do not include a complete radar sensor but only the transceiver unit operating in an analog fashion and the scanning module for generating the digitized time signal. The further digital evaluation of the signals then takes place in the central evaluation instance, which receives the time signals (raw data) from all transceiver units via the raw-data interfaces and jointly evaluates these raw data.

The distribution of the functions of the radar sensors to decentralized transceiver units for the supply of the raw data and a central evaluation instance for the further evaluation allows for an efficient production of the necessary components and an efficient real-time evaluation of the signals from a very large number of receiving channels. More specifically, short signal paths and thus short signal propagation times and correspondingly high clock rates are achievable by combining all digital evaluation functions in the central evaluation instance.

Advantageous embodiments of the present invention are disclosed herein.

According to an example embodiment of the present invention, the central evaluation instance is able to be implemented on one of the installation supports but may also be implemented in a control device which is separate from the installation supports.

The synchronization network is used for the synchronization of the high-frequency signals transmitted by the different transceiver units so that the evaluation is able to be performed on the basis of known phase relations between the signals transmitted by all antennas of the system. On the one hand, this may be achieved in that the transmit signal for all transceiver units is generated in a central location and transmitted to all transceiver units using known signal propagation times. For instance, the generation of the transmit signal may take place in the control device which also includes the evaluation instance.

In another embodiment of the present invention, the synchronization network may have a master/slave architecture in which one of the transceiver units acts as the master, that is, as a node in which the transmit signal is generated, while the other transceiver units are slaves which receive the transmit signal from the master.

In a still further embodiment of the present invention, the transmit signal is locally generated and modulated in each transceiver unit. In such a case, the synchronization network merely provides a reference signal generated in the master or the central control device, which all local oscillators use for their synchronization.

In the following text, exemplary embodiments will be described in greater detail based on the figures.

### BRIEF DESCRIPTION OF THE DRAWINGS

FIG. 1 shows a block diagram of a radar system in a first motor vehicle, according to an example embodiment of the present invention.

FIGS. 2 and 3 show block diagrams of radar systems according to other example embodiments of the present invention.

### DETAILED DESCRIPTION OF EXAMPLE EMBODIMENTS

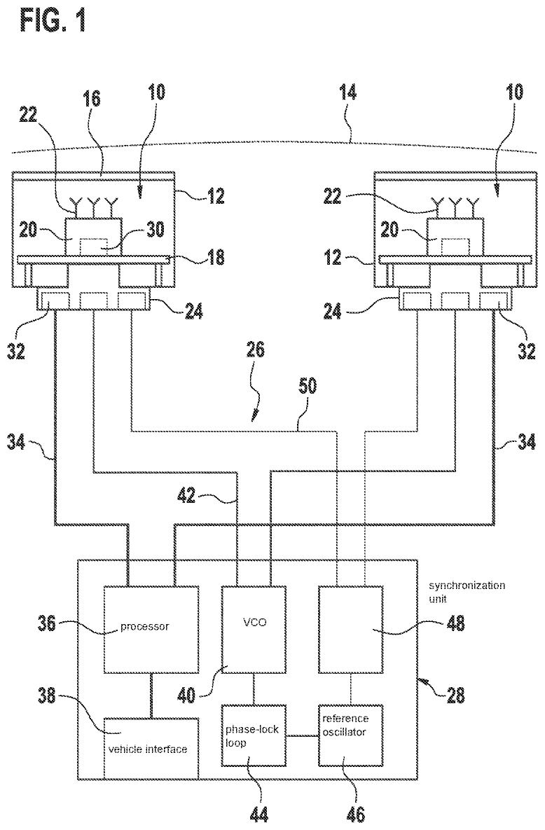

FIG. 1 schematically illustrates a radar system of a motor vehicle. The radar system includes two transceiver units 10, which are installed separately from one another on their own installation supports 12 in a motor vehicle of which only front bumper 14 is sketched by a dashed line in the drawing. For example, transceiver units 10 are installed on the left and right vehicle side in the front part of the vehicle in such a way that their radar lobes are facing forward and overlap one another at least starting at a certain distance.

Installation supports 12 are developed as self-contained housings, which are sealed on the front side by a radome 16 which is transparent to the radar waves in each case. Each housing 12 includes a board 18 on which the electronic components of the transceiver unit are situated. Virtually the entire functionality of transceiver unit 10 is implemented in a single semiconductor component 20, e.g., an MMIC (Monolithic Microwave Integrated Circuit) or a SoC (System on Chip). An antenna array 22 of each transceiver unit is shown only symbolically in the drawing and includes either separate transmit antennas and receive antennas or combined transmit and receive antennas, which are situated at an offset from one another in the transverse direction of the vehicle so that an angular resolution in the azimuth is achieved. In practice, antenna array 22 may be planar antennas on board 18 or also waveguide antennas which are disposed above semiconductor component 20 in housing 12.

Via circuit traces on board 18, each semiconductor component 20 is connected to an interface unit 24, which communicates via a synchronization network 26 with a central control device 28 which is installed in a different location in the vehicle.

As an example, it may be assumed that the radar system shown here operates according to the FMCW principle. In every measuring cycle, the transmit antennas of each transceiver unit transmit a sequence of radar signals frequency-modulated in a ramp-type manner. The signals reflected at the located objects are received by the receive antennas and mixed with a component of the signal transmitted at the receiving time so that a low-frequency beat signal is obtained for each antenna element, whose frequency and phase includes the distance and relative velocity information of the located objects. For each receive antenna, these beat signals are evaluated in a separate receiving channel. A scanning module 30 then scans and digitizes the complex amplitudes of the beat signals across the duration of the measuring cycle at a high clock cycle.

In contrast to conventional radar systems, however, the time signal obtained in this way is not analyzed further right there and then but transmitted via a raw-data interface 32 of interface unit 24 and via a digital data line 34 to control device 28 where the time signals from both transceiver units 10 are jointly evaluated in a fast processor 36. Processor 36 thus represents a central evaluation instance for the overall system. In the course of the evaluation, the time signal in each receiving channel is converted by a fast Fourier transform into a spectrum in which each located object manifests itself in the form of a peak at a certain frequency. By comparing the data obtained on different frequency ramps, the distance information is separated from the relative-velocity information in a conventional manner so that the distance and the relative velocity of each located object are able to be determined. In addition, the azimuth angle of each located object is determined by comparing the amplitudes and phases of the signals received in different receiving channels. The information about the located objects obtained in this way is output via a vehicle interface 38, e.g., a fast Ethernet interface or a CAN bus, to other electronic components in the vehicle such as a driver-assistance system.

In this embodiment, control device 28 furthermore includes a voltage-controlled oscillator 40 (VCO), which generates the frequency-modulated transmit signal for both transceiver units and outputs it via high-frequency lines 42 of the synchronization network to interface units 24. The ramp-type frequency modulation is implemented with the aid of a phase-lock loop 44 based on a clock signal that is generated by a reference oscillator 46 in control device 28. The clock signal of reference oscillator 46 also controls the mode of operation of a synchronization unit 48 which generates the synchronization and clock signals for the coordination of the mode of operation of the two transceiver units 10 and outputs them via lines 50 of synchronization network 26 to interface units 24.

Simply for reasons of clarity, the structure of the two interface units 24 is shown in mirror symmetry in the drawing. In practice, however, the complete transceiver units may have the same development so that an efficient production is possible.

Since the radar signals transmitted by the two transceiver units are synchronized, it is also possible to evaluate signals in processor 36 that are transmitted by one of the transceiver units and received by the other one. The two antenna arrays 22 then form an overall array featuring a very large aperture, which allows for a high-resolution angle measurement by virtue of the great distance between installation supports 12.

The lengths of high-frequency lines 42 may be dimensioned so that the transmit signals arrive in phase at interface units 24. As an alternative, a fixed and known phase difference may be permitted between these signals and then taken into account in the evaluation in processor 36.

In the simple example shown here, the radar system has only two transceiver units 10. In practice, however, the number of transceiver units may be considerably higher. Data lines 34 may then extend in the form of a star from control device 28 to individual transceiver units 10. As an alternative, however, it is also possible to connect the transceiver units to one another in a serial manner and to control device 28. The same also applies to high-frequency lines 42 and lines 50 of the synchronization network.

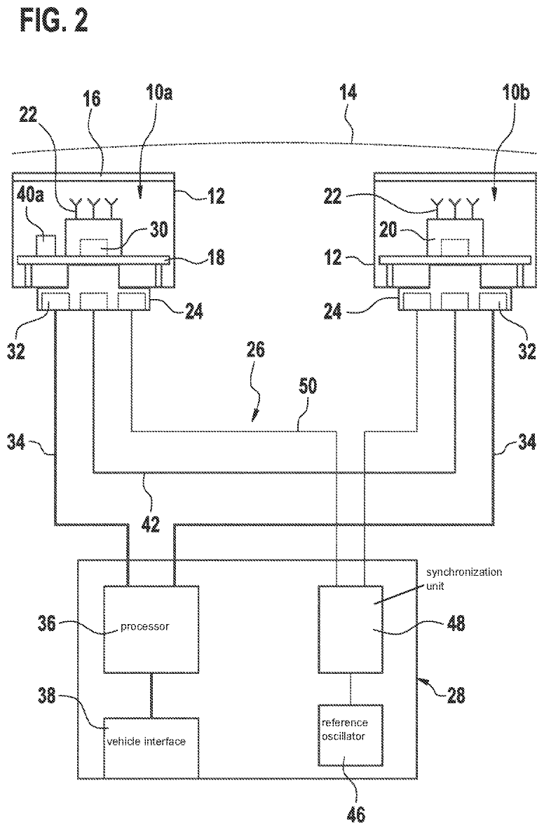

As a modified exemplary embodiment, FIG. 2 shows a radar system having two transceiver units 10a, 10b, which has a master/slave architecture with regard to the generation of the high-frequency signal. Transceiver 10a is configured as a master and has a local oscillator 40a, which supplies the high-frequency signal for all transceiver units. Second transceiver unit 10b or—in a network having multiple nodes—all other transceiver units are slaves, which receive the transmit signal via high-frequency lines 42 from the master.

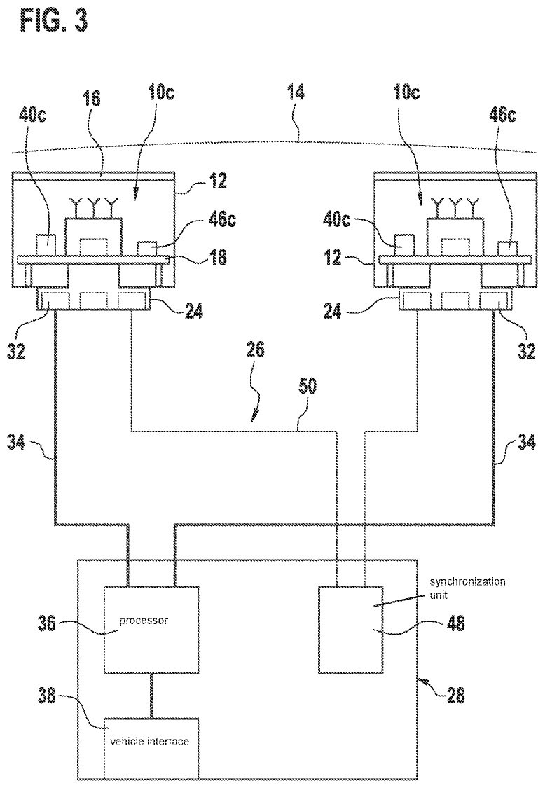

FIG. 3 shows another exemplary embodiment, in which the generation and modulation of the high-frequency signal takes place locally in each transceiver unit 10c. To this end, each transceiver unit has a local oscillator 40c and a reference oscillator 46c. The synchronization is implemented with the aid of a time reference transmitted via synchronization network 26.

All other features of the radar system described here with reference to FIG. 1 are able to be realized in a similar manner also in the embodiments according to FIGS. 2 and 3.

1-5. (canceled)

6. A radar system for a motor vehicle, comprising:
a plurality of transceiver units, which are situated on separate installation supports for installation in different locations in the motor vehicle and are connected to one another by a synchronization network, each of the transceiver units includes a scanning module for scanning radar signals received on a plurality of channels in the form of a time signals;
wherein each of the installation supports has a raw-data interface for transmitting the time signal of the transceiver unit to a central evaluation instance, and the central evaluation instance is configured to jointly evaluate the time signals from the plurality of transceiver units.

7. The radar system as recited in claim 6, wherein, the central evaluation instance is a processor in a control device which is separate from the installation supports.

8. The radar system as recited in claim 6, wherein an oscillator is situated at a location of the central evaluation instance for generation of a transmit signal for all of the transceiver units.

9. The radar sensor as recited in claim 6, wherein an oscillator is disposed on one of the installation supports for generation of a transmit signal for all of the transceiver units.

10. The radar system as recited in claim 6, wherein each transceiver unit of the transceiver units has a local oscillator for generation of a transmit signal for the transceiver unit, and the local oscillators are synchronized with one another via the synchronization network.
